(19) United States
(12) Patent Application Publication
(10) Pub. No.: US 2026/0000222 A1
(43) Pub. Date: Jan. 1, 2026

(54) FOLDABLE CARRIER AND CHILD CARRYING DEVICE

(71) Applicant: WONDERLAND SWITZERLAND AG, Steinhausen (CH)

(72) Inventor: Jialiang YUAN, Dongguan (CN)

(21) Appl. No.: 18/880,774

(22) PCT Filed: Jul. 7, 2023
(86) PCT No.: PCT/EP2023/068880

§ 371 Date: Jan. 2, 2025

(30) Foreign Application Priority Data
Jul. 8, 2022 (CN) 202210806843.5

(51) Int. Cl. A47D 13/02; B62B 7/06; B62B 7/14; B62B 9/10

(52) U.S. Cl. CPC A47D 13/025; A47D 13/027; B62B 7/06; B62B 7/14; B62B 9/104; B62B 2205/20

(57) ABSTRACT

The present application relates to a foldable carrier and a child carrying device. The foldable carrier includes a seat assembly, an armrest support rod, a backrest support rod, a locking mechanism, and a linkage mechanism. The armrest support rod is pivotable relative to the seat assembly to move between a folded position and an unfolded position. The backrest support rod has a folded position and an unfolded position. The locking mechanism is configured to lock the armrest support rod in the unfolded position relative to the seat assembly. The linkage mechanism is arranged between the armrest support rod and the backrest support rod. The backrest support rod is folded in a direction approaching the armrest support rod to drive the linkage mechanism to move to unlock the locking mechanism so that the armrest support rod is capable of being rotated to the folded position.

### CROSS-REFERENCE TO RELATED APPLICATIONS

This application is a National Stage application of PCT/EP2023/068880, filed on Jul. 7, 2023, which claims the benefit of Chinese Application No. 202210806843.5, filed on Jul. 8, 2022, the content of which is incorporated herein by reference in its entirety.

### TECHNICAL FIELD

The present application relates to the technical field of baby carriers, and in particular, to a foldable carrier and a child carrying device.

### BACKGROUND

Child carrying devices currently available on the market, such as baby carriages, generally have a foldable function in order to facilitate storage and transportation. However, after seats of many child carrying devices are folded, armrests thereof generally cannot be folded with the whole carriers of the child carrying devices. In many cases, there is a need to disassemble the armrests to cooperate with the entire carriers for folding. On the one hand, this brings inconvenience to consumers, and on the other hand, the disassembled armrests are also easy to lose.

### SUMMARY

Accordingly, it is necessary to provide a foldable carrier and a child carrying device. The foldable carrier and an armrest of the child carrying device can be folded along with the whole carrier of the child carrying device, which is convenient to use. A foldable carrier, including:
a seat assembly;
an armrest support rod pivotable relative to the seat assembly to move between a folded position and an unfolded position;
a backrest support rod having a folded position and an unfolded position;
a locking mechanism configured to lock the armrest support rod in the unfolded position relative to the seat assembly; and
a linkage mechanism arranged between the armrest support rod and the backrest support rod, the backrest support rod being is capable of being folded in a direction approaching the armrest support rod to drive the linkage mechanism to move to unlock the locking mechanism, so that the armrest support rod is capable of being rotated to the folded position.

In the above foldable carrier, both the armrest support rod and the backrest support rod have a folded position and an unfolded position. When the foldable carrier is required to be folded, only the backrest support rod is required to be folded in the direction approaching the armrest support rod, which can drive, through the linkage mechanism, the locking mechanism to be unlocked, so that the armrest support rod can be rotated relative to a side plate, and the armrest support rod can be rotated from the unfolded position to the folded position with the backrest support rod, so as to realize overall folding of the foldable carrier without disassembling the armrest support rod, which is convenient to use.

In an embodiment, the seat assembly includes a side plate, the locking mechanism includes a locking member and a locking pin. The locking member is pivotally connected to the side plate at a first pivot point, and is fixedly connected to the armrest support rod. The locking member is provided with a locking groove. The locking pin is movably arranged on the side plate and capable of being inserted into the locking groove.

In an embodiment, the backrest support rod is capable of being folded in the direction approaching the armrest support rod to drive the linkage mechanism to move, so that the locking pin moves in a direction away from the locking member.

In an embodiment, the linkage mechanism includes a driving member, a transmission member, and a pulling member. The driving member is fixedly connected to the backrest support rod. The driving member abuts against the transmission member. Two ends of the pulling member are connected to the transmission member and the locking pin respectively. The backrest support rod is capable of being folded in the direction approaching the armrest support rod to drive the driving member to push against the transmission member to move, so as to drive, through the pulling member, the locking pin to move in the direction away from the locking member.

In an embodiment, the linkage mechanism further includes a winding post. The winding post is arranged on a side of the transmission member away from the locking pin. One end of the pulling member is connected to the transmission member, the other end of the pulling member is wound around the winding post and is connected to the locking pin. The backrest support rod is capable of being folded in the direction approaching the armrest support rod, to drive the driving member to push against the transmission member to move in a direction approaching the locking member.

In an embodiment, the side plate is provided with an elongated hole. The transmission member extends through the elongated hole and is movable along the elongated hole.

In an embodiment, the driving member is pivotally connected to the side plate at a second pivot point. The driving member includes an arc-shaped edge configured for abutting against the transmission member. As the backrest support rod is folded in the direction approaching the armrest support rod, a distance from an abutment point of the arc-shaped edge against the transmission member to the second pivot point gradually increases.

In an embodiment, the locking mechanism further includes a first reset member. The first reset member constantly enables the locking pin to move in a direction approaching the locking member.

In an embodiment, the locking mechanism further includes a second reset member, the locking member has a first position and a second position. When the armrest support rod is in the unfolded position, the locking member is in the first position. When the armrest support rod is in the folded position, the locking member is in the second position. The second reset member constantly enables the locking member to rotate toward the first position.

In an embodiment, the side plate is provided with a limiting member. When the locking member is in the first position, a side of the locking member adjacent to the second reset member abuts against the limiting member.

In an embodiment, a first mating portion is arranged on the armrest support rod, and a second mating portion is arranged on the locking member. The armrest support rod and the locking member are arranged on two sides of the side plate respectively.

In an embodiment, the first mating portion is one of a mating protrusion and a mating recess, and the second mating portion is the other of the mating protrusion and the mating recess. The mating protrusion extends through the side plate to be mated with the mating recess.

In an embodiment, the seat assembly further includes a seat body. Two opposite sides of the seat body are each provided with the side plate, the armrest support rod, the backrest support rod, the locking mechanism, and the linkage mechanism. The two side plates are connected to the two sides of the seat body respectively.

The present application further provides a child carrying device, including a carrier frame and the foldable carrier as described above.

In an embodiment, the child carrying device is a child stroller, a high chair, or a child dining chair.

### BRIEF DESCRIPTION OF THE DRAWINGS

FIG. 1 is a schematic structural diagram of a child carrying device according to an embodiment of the present application.

FIG. 2 is a schematic structural diagram of a foldable carrier in the child carrying device shown in FIG. 1.

FIG. 3 is a side view of the foldable carrier shown in FIG. 2, with the foldable carrier in an unfolded state.

FIG. 4 is a schematic structural diagram of the foldable carrier shown in FIG. 3 in a half-folded state.

FIG. 5 is a schematic structural diagram of the foldable carrier shown in FIG. 3 in a folded state.

FIG. 6 is a schematic structural diagram of the foldable carrier shown in FIG. 2 from another perspective, with the foldable carrier in an unfolded state.

FIG. 7 is an enlarged view of a portion A in FIG. 6.

FIG. 8 is a schematic structural diagram of the foldable carrier shown in FIG. 6 subjected to a certain angle adjustment by a backrest support rod, with the foldable carrier in the unfolded state.

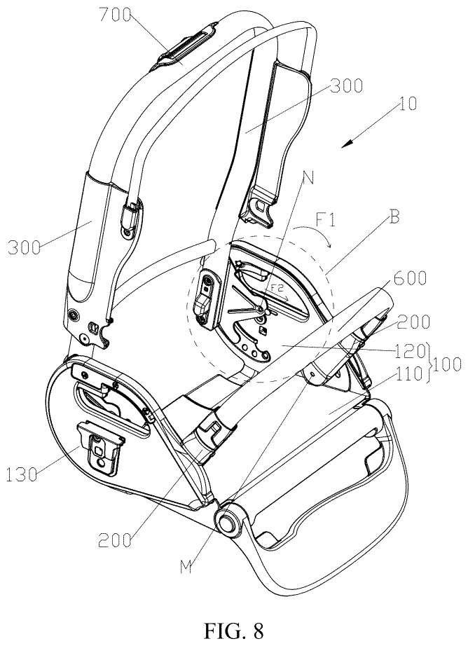

FIG. 9 is an enlarged view of a portion B in FIG. 8.

FIG. 10 is a schematic structural diagram of the foldable carrier shown in FIG. 6 in a half-folded state.

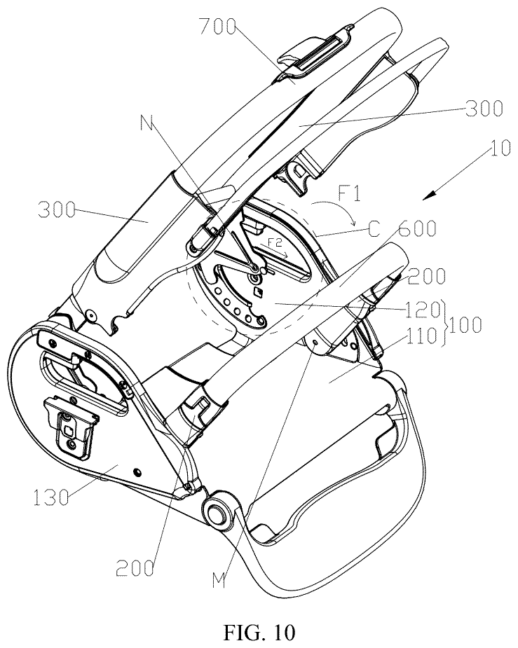

FIG. 11 is an enlarged view of a portion C in FIG. 10.

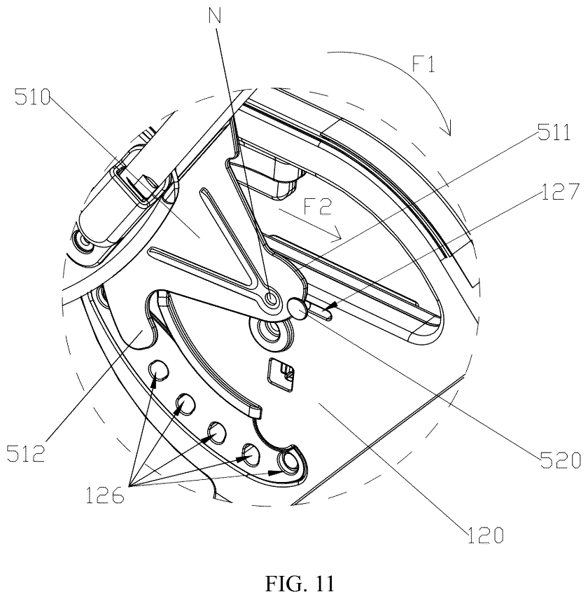

FIG. 12 is a schematic structural diagram of the foldable carrier shown in FIG. 2 with a side cover removed and the foldable carrier in an unfolded state.

FIG. 13 is an enlarged view of a portion D in FIG. 12.

FIG. 14 is another schematic structural diagram of FIG. 13 with a side plate removed.

FIG. 15 is a schematic structural diagram of the foldable carrier shown in FIG. 4 with a side cover removed, and the foldable carrier in the half-folded state.

FIG. 16 is an enlarged view of a portion E in FIG. 15.

FIG. 17 is a schematic structural diagram of the foldable carrier shown in FIG. 5 with a side cover removed, and the foldable carrier is in the folded state.

FIG. 18 is an enlarged view of a portion F in FIG. 17.

FIG. 19 is a schematic structural diagram of an armrest support rod shown in FIG. 14.

FIG. 20 is a schematic structural diagram of a locking member shown in FIG. 14.

### ILLUSTRATIONS FOR REFERENCE SIGNS

10. foldable carrier, 100. Seat assembly, 110. Seat body, 120. Side plate, 121. Limiting member, 122. Limiting protrusion, 123. Sliding groove, 124. Abutting protrusion, 125. Second fixed post, 126. Positioning hole, 127. elongated hole, 130. Side cover, 200. Armrest support rod, 210. mating recess, 300. Backrest support rod, 400. Locking mechanism, 410. Locking member, 411. rotary portion, 411a. mating protrusion, 412. Locking portion, 412a. first side, 412b. second side, 412c. locking groove, 412d. first fixed hole, 420. Locking pin, 430. First reset member, 440. Second reset member, 500. Linkage mechanism, 510. Driving member, 511. Arc-shaped edge, 512. Positioning portion, 520. Transmission member, 530. pulling member, 540. Winding post, 600. Armrest body, 700. Backrest body, 20. Carrier frame, M. first pivot point, N. second pivot point.

### DETAILED DESCRIPTION OF THE EMBODIMENTS

In order to make the above objects, technical solutions, and advantages of the present application more obvious and understandable, the present application is described in further detail below with reference to the accompanying drawings and specific embodiments. It should be understood that specific embodiments described herein are intended only to explain the present application, and are not intended to limit the protection scope of the present application.

It should be noted that when one element is referred to as “fixed to” another element, it may be directly disposed on the another element or an intermediate element may exist. When one element is considered to be “connected to” another element, it may be directly connected to the another element or an intermediate element may co-exist. The terms “vertical”, “horizontal”, “left”, “right” and similar expressions used herein are for illustrative purposes only, and are not meant to be unique embodiments.

Unless defined otherwise, all technical and scientific terms used herein have the same meanings as would generally understood by those skilled in the technical field to which the present application belongs. The terms used herein in the specification of the present application are for the purpose of describing specific embodiments only, and are not intended to limit the present application. The term “and/or” used herein includes any and all combinations of one or more associated listed items.

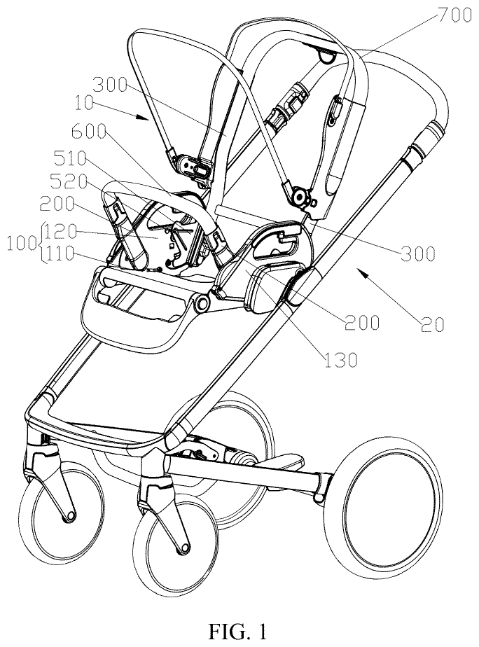

As shown in FIG. 1, an embodiment of the present application provides a child carrying device, for example, a child stroller, including a foldable carrier 10 and a carrier frame 20. The foldable carrier 10 can be detachably or non-detachably mounted on the carrier frame 20. Certainly, in other embodiments, the child carrying device may alternatively be a high chair, a child dining chair, or the like. The foldable carrier 10 and an armrest support rod 200 of the child carrying device can be folded along with folding of a backrest support rod 300, which is convenient to use.

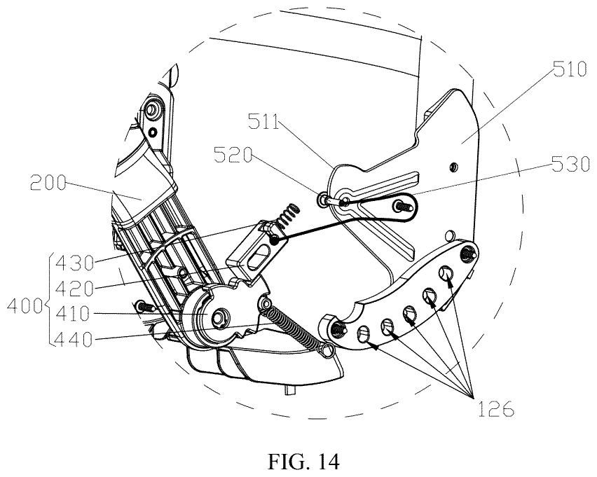

Specifically, as shown in FIGS. 1, 13, and 14, the foldable carrier 10 includes a seat assembly 100, an armrest support rod 200, a backrest support rod 300, a locking mechanism 400, a linkage mechanism 500, an armrest body 600, and a backrest body 700. The seat assembly 100 includes a seat body 110, two side plates 120, and two side covers 130. The seat body 110 is configured to carry a child. The two side plates 120 are respectively connected to two opposite sides of the seat body 110, that is, left and right sides of the seat body 110. In this embodiment, the seat body 110 and the two side plates 120 are integrally formed. Certainly, in other embodiments, the seat body 110 and the two side plates 120 may alternatively be components independent of each other. The two side covers 130 respectively cover sides of the two side plates 120 facing away from the seat body 110, that is, outer sides of the two side plates 120, so as to form mounting spaces respectively. The left and right sides of the seat body 110 are each further provided with the armrest support rod 200, the backrest support rod 300, the locking mechanism 400, and the linkage mechanism 500. Two ends of the armrest body 600 may be detachably connected to the armrest support rods 200 arranged on the two sides of the seat body 110 respectively. Two ends of the backrest body 700 are connected to the backrest support rods 300 arranged on the two sides of the seat body 110 respectively.

A configuration of the foldable carrier 10 is specifically described below by taking the side plate 120, the armrest support rod 200, the backrest support rod 300, the locking mechanism 400, and the linkage mechanism 500 arranged on one side of the seat body 110 as an example.

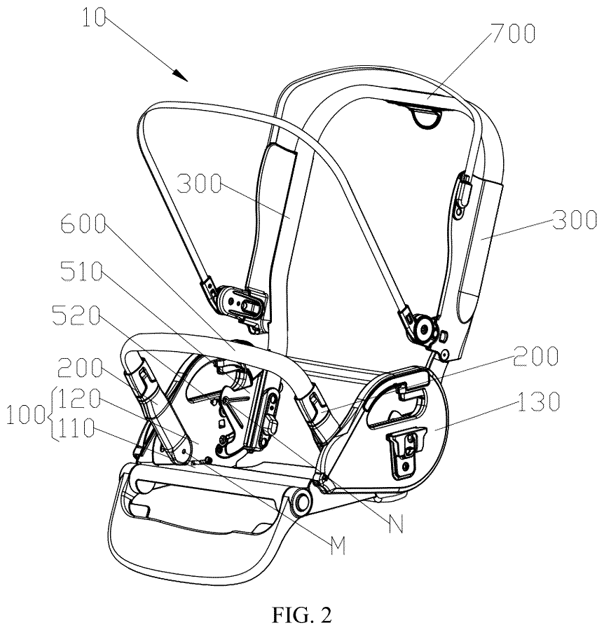

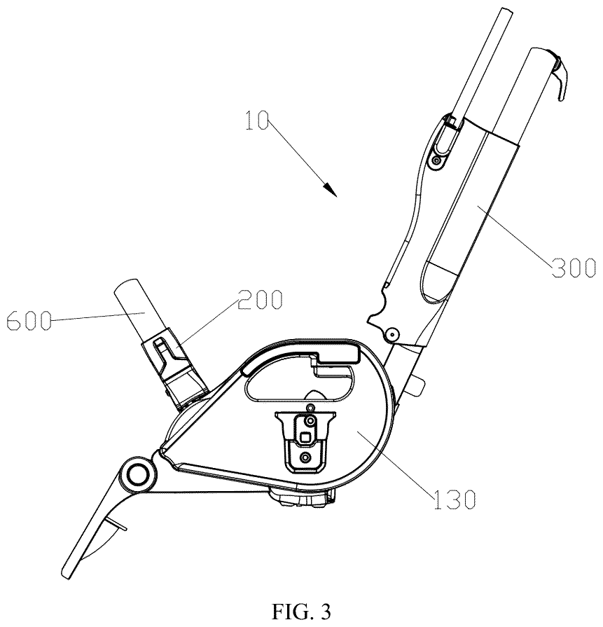

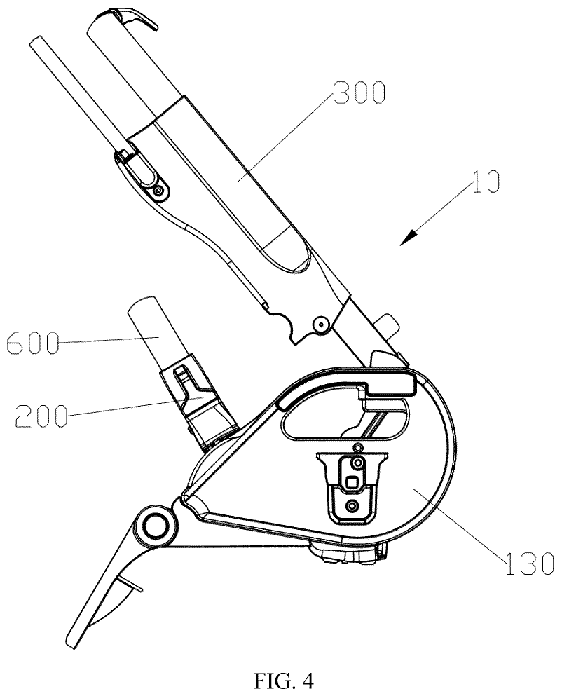

As shown in FIG. 2, the armrest support rod 200 is pivotally connected to the side plate 120 at a first pivot point M, and the backrest support rod 300 is pivotally connected to the side plate 120 at a second pivot point N through a driving member 510 (see details later). In this embodiment, both the armrest support rod 200 and the backrest support rod 300 are arranged on a side of the side plate 120 facing the seat body 110, that is, an inner side of the side plate 120. As shown in FIGS. 3 to 5, both the armrest support rod 200 and the backrest support rod 300 have an unfolded position and a folded position. When the armrest support rod 200 and the backrest support rod 300 are in the unfolded position, the foldable carrier 10 may allow the child to be seated. When the armrest support rod 200 and the backrest support rod 300 are in the folded position, the foldable carrier 10 may be stored and placed. Both the locking mechanism 400 and the linkage mechanism 500 are arranged on the side plate 120 and are arranged between the armrest support rod 200 and the backrest support rod 300. The locking mechanism 400 is configured to lock the armrest support rod 200 in the unfolded position relative to the side plate 120. The backrest support rod 300 is folded in a direction approaching the armrest support rod 200, which can drive the linkage mechanism 500 to move to unlock the locking mechanism 400 so that the armrest support rod 200 may be rotated to the folded position relative to the side plate 120 (see details later).

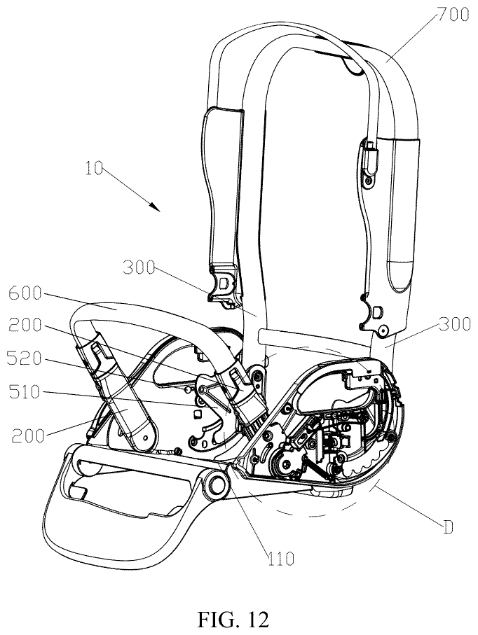

Specifically, as shown in FIGS. 12 to 14, the locking mechanism 400 is arranged in the mounting space. That is, the locking mechanism 400 is arranged on the side of the side plate 120 facing away from the seat body 110, that is, the outer side of the side plate 120. The locking mechanism 400 includes a locking member 410, a locking pin 420, a first reset member 430, and a second reset member 440.

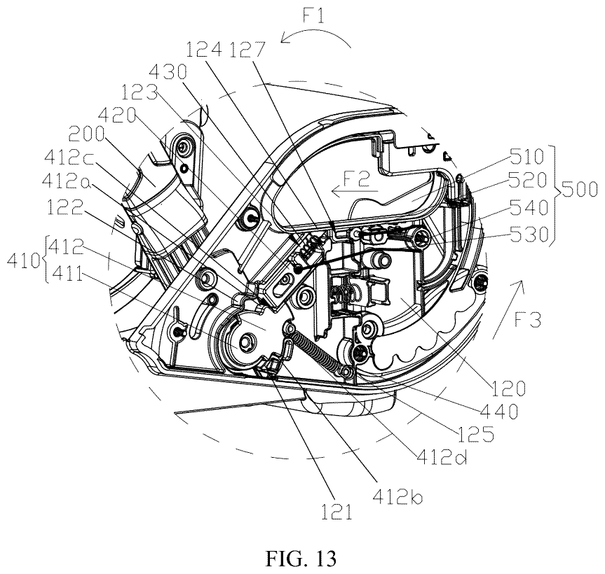

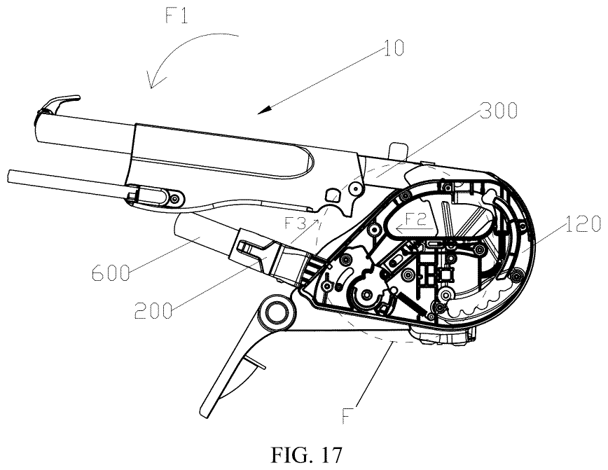

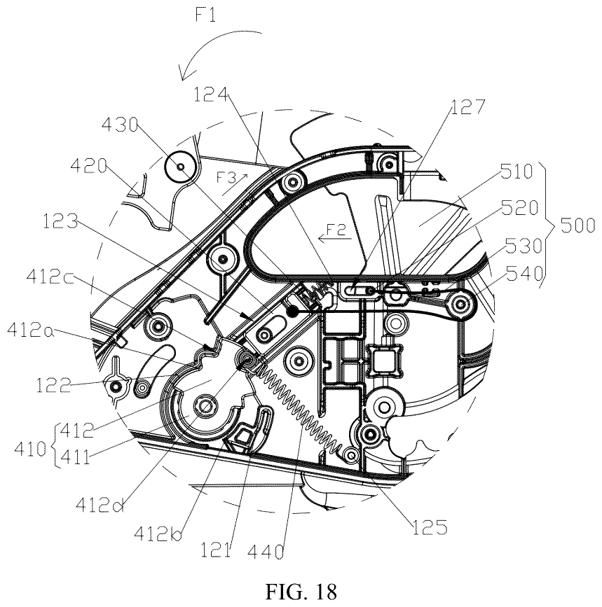

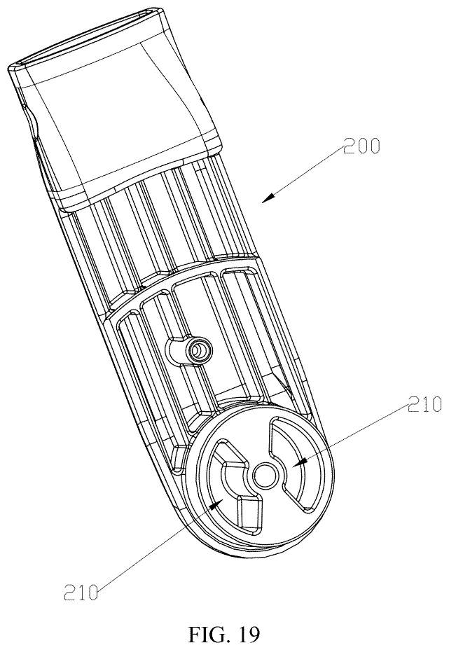

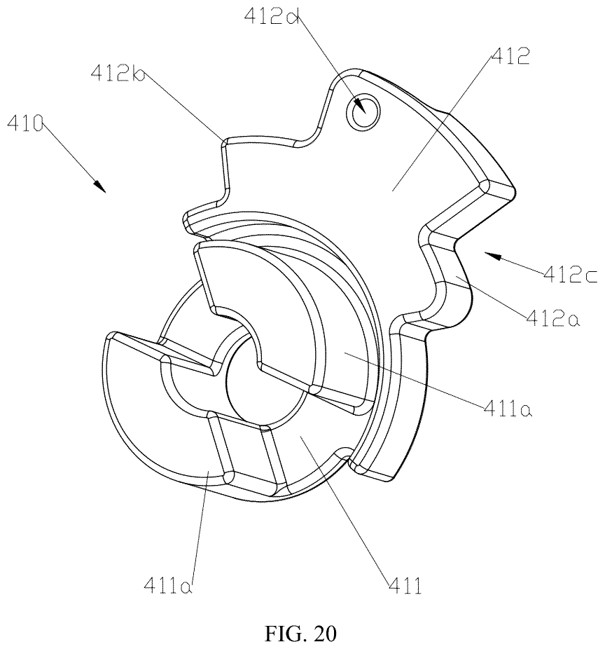

Further, as shown in FIGS. 12 to 14, the locking member 410 is arranged on the side plate 120 and includes a rotary portion 411 and a locking portion 412 connected to the rotatable portion 411. As shown in FIGS. 19 and 20, two fan-shaped hollow mating protrusions 411a are arranged on a side of the rotary portion 411 facing the side plate 120, and an end of the armrest support rod 200 pivotally connected to the side plate 120 is provided with two fan-shaped mating recesses 210 matching the mating protrusions 411a. The side plate 120 may be provided with a mating hole (not shown in the figure). the two mating protrusions 411a may extend through the mating hole to be respectively inserted into the two mating recesses 210, so that the locking member 410 can be fixedly connected to the armrest support rod 200. The locking member 410 and the armrest support rod 200 may be rotated synchronously. As shown in FIGS. 12 and 13, when the armrest support rod 200 is in the unfolded position, the locking member 410 is in a first position. As shown in FIGS. 17 and 18, when the armrest support rod 200 is in the folded position, the locking member 410 is in a second position. Certainly, in other embodiments, the rotary portion 411 may alternatively be provided with a first mating portion of another type, and the armrest support rod 200 is provided with a second mating portion matching the first mating portion. The first mating portion or the second mating portion mat extend through the side plate 120 and is mated with the second mating portion or the first mating portion. Alternatively, the locking member 410 and the armrest support rod 200 may also be fixedly connected through a fastener such as a rivet.

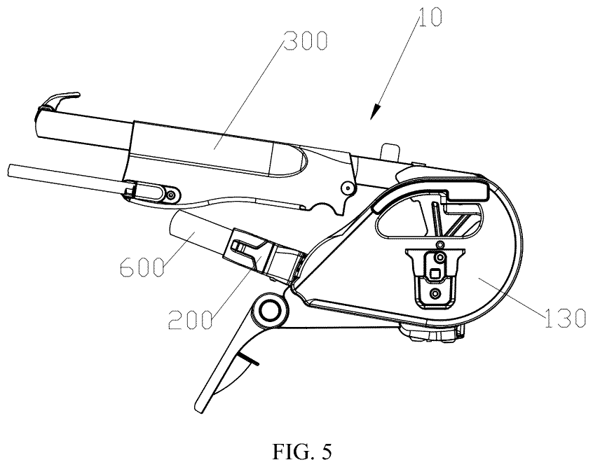

As shown in FIGS. 13 and 20, the locking portion 412 includes a first side 412a and a second side 412b opposite to the first side 412a. A locking groove 412c is arranged on the first side 412a. Further, the side plate 120 is provided with a limiting member 121 and a limiting protrusion 122. When the locking member 410 is in the first position, the second side 412b abuts against the limiting member 121. When the locking member 410 is in the second position, the first side 412a abuts against the limiting protrusion 122. In this embodiment, both the first side 412a and the second side 412b have a zigzag structure. The limiting protrusion 122 and the limiting member 121 each have a zigzag structure. The zigzag structures of the limiting protrusion 122 and the limiting member 121 are mated with the first side 412a and the second side 412b. In this way, a rotation angle of the locking member 410 can be limited within a reasonable range, that is, a rotation angle of the armrest support rod 200 can be limited within a reasonable range, so that, when the armrest body 600 connected to the armrest support rod 200 is in the unfolded position (as shown in FIG. 3), an unfolding angle may allow that the child seated on the seat body 110 may be supported by a caregiver; and when the armrest body 600 is in the folded position (as shown in FIG. 5), a folded angle is sufficient to allow the backrest support rod 300 to be folded until it is convenient for the user to store the foldable carrier 10. In this embodiment, the locking member 410 is integrally formed. Certainly, in other embodiments, the locking member 410 may alternatively be formed by connecting the rotary portion 411 and the locking portion 412 independent of each other.

Further, as shown in FIG. 13, the locking pin 420 is movably arranged on the side plate 120 and can be inserted into the locking groove 412c. Specifically, a sliding groove 123 extending obliquely toward the locking member 410 may be arranged on the side plate 120, and the locking pin 420 is slidably arranged in the sliding groove 123.

Further, as shown in FIG. 13, one end of the first reset member 430 abuts against an end of the locking pin 420 away from the locking member 410, and the other end of the first reset member 430 abuts against the side plate 120, which may specifically abut against an abutting protrusion 124 on the side plate 120. The first reset member 430 and the locking pin 420 may be arranged in the lock sliding groove 123. The first reset member 430 biases the locking pin 420 to constantly enable the locking pin 420 to move in a direction approaching the locking member 410. In this embodiment, the first reset member 430 is a spring.

Further, as shown in FIG. 13, one end of the second reset member 440 is connected to the second side 412b, and the other end of the second reset member 440 is connected to the side plate 120. The second reset member 440 constantly enables the locking member 410 to rotate toward the first position. In this embodiment, the second reset member 440 is a tension spring. A first fixed hole 412d is arranged on the second side 412b, and a second fixed post 125 is arranged on the side plate 120. Two connecting rings at two ends of the tension spring are respectively fixed to the first fixed hole 412d and the second fixed post 125. However, the present application is not limited thereto. In a modified embodiment of this embodiment, a fixed post may be arranged on the second side 412b, and the two connecting rings at two ends of the tension spring may be sleeved on the fixed post on the second side 412b and the second fixed post 125 respectively.

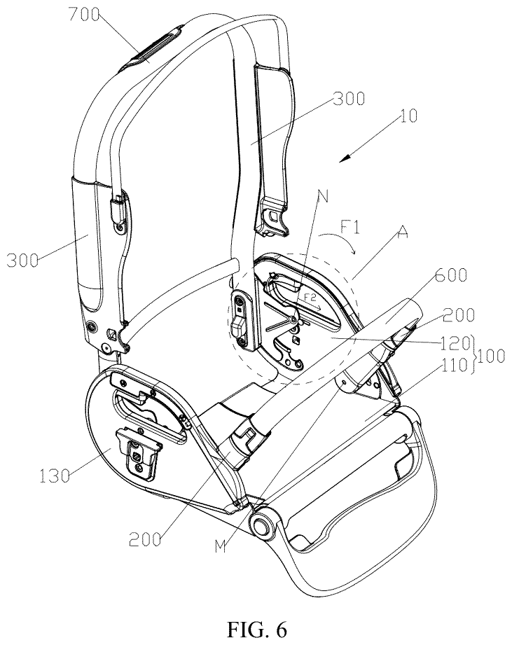

Specifically, as shown in FIGS. 6, 7, 13, and 14, the linkage mechanism 500 includes a driving member 510, a transmission member 520, a pulling member 530, and a winding post 540. The driving member 510 is arranged on an inner side of the side plate 120. The transmission member 520 extends through the side plate 120. Both the pulling member 530 and the winding post 540 are arranged on the outer side of the side plate 120, that is, arranged in the mounting space. The driving member 510 roughly has a triangular sheet structure. One side of the driving member 510 is fixedly connected to the backrest support rod 300 in such a way that the driving member 510 cannot move relative to the backrest support rod 300. A corner of the driving member 510 opposite to the backrest support rod 300 is pivotally connected to the side plate 120 at the second pivot point N and includes an arc-shaped edge 511 for abutting against the transmission member 520. An outer contour of the arc-shaped edge 511 is designed such that a distance from an abutment point of an outer contour against the transmission member 520 to the second pivot point N gradually increases, as the backrest support rod 300 is pivoted and is folded in a direction F1 approaching the armrest support rod 200. That is, a distance from the abutment point of the arc-shaped edge 511 against the transmission member 520 to the second pivot point N gradually increases roughly in a direction opposite to the direction F1. A positioning portion 512 is further arranged on the driving member 510. A plurality of positioning holes 126 are arranged on the side plate 120. When the backrest support rod 300 is rotated in a direct close to or away from the armrest body 600, the positioning portion 512 can be selectively inserted into any one of the positioning holes 126 to adjust an inclination angle of the backrest support rod 300.

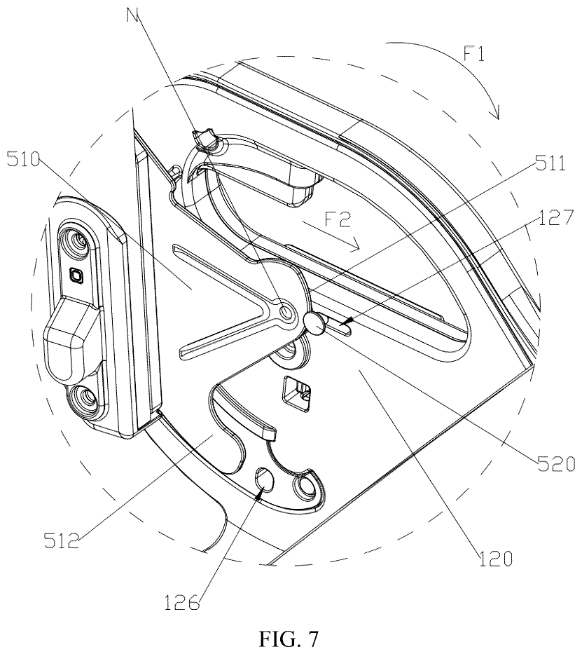

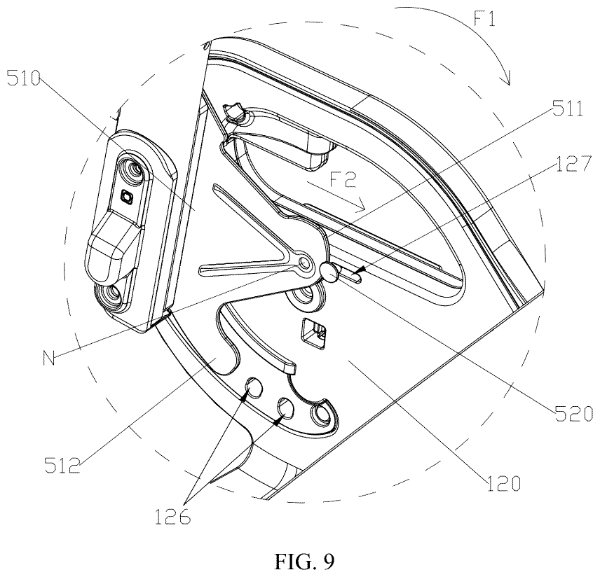

Further, as shown in FIGS. 7, 9, 13, and 14, the transmission member 520 roughly has a post structure. An elongated hole 127 substantially arranged in a horizontal direction (i.e., a direction F2) is arranged on the side plate 120, and the transmission member 520 extends through the elongated hole 127 and can move along the elongated hole 127. In this way, one end of the transmission member 520 arranged on the inner side of the side plate 120 can abut against the arc-shaped edge 511 of the driving member 510, and the other end of the transmission member 520 arranged on the outer side of the side plate 120 can be connected to the pulling member 530. As the backrest support rod 300 is folded in the direction F1 approaching the armrest support rod 200, the arc-shaped edge 511 pushes against the transmission member 520 to move in the elongated hole 127 in the direction F2.

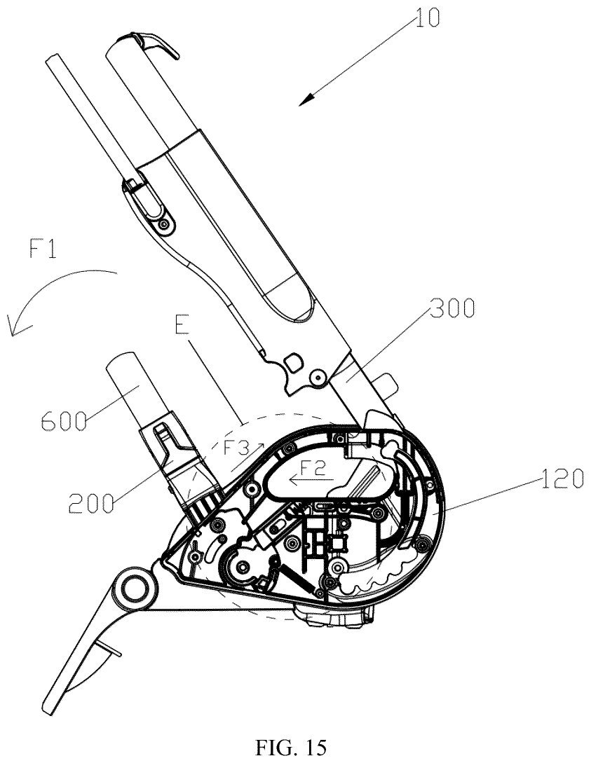

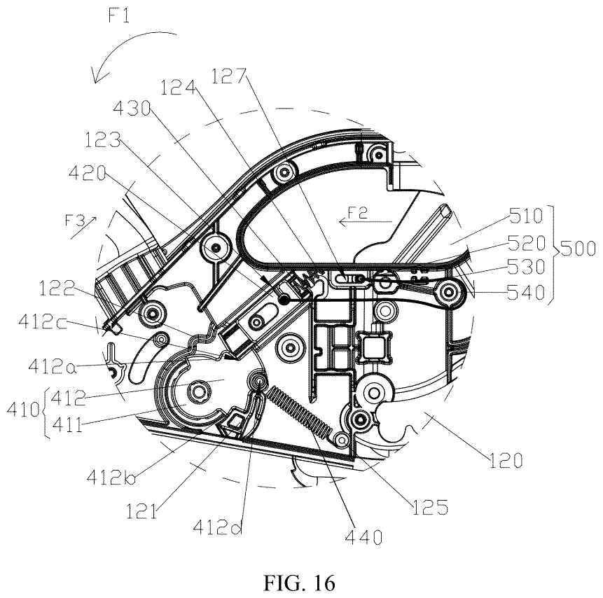

Further, as shown in FIGS. 12 and 13, the winding post 540 is arranged on a side of the transmission member 520 away from the locking pin 420. That is, the transmission member 520 is arranged in the direction F2 with respect to the winding post 540. In other words, the transmission member 520 is roughly arranged between the locking pin 420 and the winding post 540. In this embodiment, the winding post 540 may be a rotating shaft of the driving member 510 arranged at the second pivot point N, so that machining procedures can be reduced. In this embodiment, the pulling member 530 is a steel wire. Certainly, in other embodiments, the pulling member 530 may alternatively be other ropes that can pull the locking pin 420 to slide. One end of the pulling member 530 is connected to the transmission member 520, and the other end of the pulling member 530 is wound around the winding post 540 and is connected to the locking pin 420. In this way, the transmission member 520, the pulling member 530, the winding post 540, and the locking pin 420 form a structure that can change a moving direction of the pulling member 530, so that the transmission member 520 can drive, through the pulling member 530, the locking pin 420 to move in an opposite position or an intersecting direction to a direction in which the transmission member 520 is moved. For example, as shown in FIGS. 15 and 16, when the backrest support rod 300 is folded in the direction F1 and in a direction approaching the armrest support rod 200, the arc-shaped edge 511 pushes against the transmission member 520 to move in the direction F2 and in a direction approaching the locking member 410, and the transmission member 520 simultaneously applies a force in a direction opposite to the direction F2 to the locking pin 420 through the pulling member 530, so that the locking pin 420 moves in a direction F3 under limitation of the sliding groove 123, that is, moves in a direction away from the locking member 410. When the locking pin 420 is disengaged from the locking groove 412c, the locking mechanism 400 is unlocked, as shown in FIGS. 17 and 18.

A specific operating principle of the above foldable carrier 10 is as follows.

As shown in FIGS. 12 and 13, when the armrest support rod 200 and the backrest support rod 300 are in the unfolded state, the locking pin 420 is inserted and locked in the locking groove 412c. In this case, if the foldable carrier 10 is required to be folded, as shown in FIGS. 15 and 16, the backrest support rod 300 is pressed down in a direction approaching the armrest support rod 200 (that is, the direction F1). At the same time, the backrest support rod 300 drives the driving member 510 to rotate in the direction F1, and the arc-shaped edge 511 of the driving member 510 pushes against the transmission member 520 in the direction F2, and the transmission member 520 pulls the locking pin 420 through the pulling member 530 at the same time, so that the locking pin 420 in the sliding groove 123 is moved in the direction F3 and is gradually moved away from the locking member 410. When the locking pin 420 moves to be disengaged from the locking groove 412c, the locking mechanism 400 is unlocked, and the locking member 410 and the armrest support rod 200 driven by the locking member 410 may be rotated relative to the side plate 120. The backrest support rod 300 that is pressed down presses against the armrest body 600, and drives the armrest body 600 and the armrest support rod 200 to move in a direction approaching the seat body 110 until the folding is completed. In this case, as shown in FIGS. 17 and 18, the driving member 510 is positioned at the second position, the first reset member 430 is compressed, the second reset member 440 is stretched, and the first side 412a of the locking member 410 abuts against the limiting protrusion 122.

If the foldable carrier 10 in a folded state is required to be unfolded for use, as shown in FIGS. 15 and 16, the backrest support rod 300 is pulled in a direction away from the armrest support rod 200. Then, the backrest support rod 300 drives the driving member 510 to move in a direction opposite to the direction F1, so that the driving member 510 cannot push against the transmission member 520 in the direction F2. Then, the transmission member 520 cannot pull the locking pin 420 in the direction F3, and then the locking pin 420 moves toward the locking member 410 in a direction opposite to the direction F3 under an elastic force of the first reset member 430. At the same time, the armrest support rod 200 does not apply a pressing force to the armrest body 600, and the locking member 410 is rotated toward the first position under the elastic force of the second reset member 440 until the locking groove 412c faces the locking pin 420, and then the locking pin 420 is inserted into the locking groove 412c, so that the armrest support rod 200 and the side plate 120 are re-locked, and the second side 412b of the locking member abuts against the limiting member 121, as shown in FIGS. 12 and 13.

Certainly, in other embodiments, the linkage mechanism 500 may alternatively be configured in another form, provided that the linkage mechanism 500 can be driven to move when the backrest support rod 300 is folded in the direction approaching the armrest support rod 200, so that the locking pin 420 moves in the direction away from the locking member 410. For example, in another embodiment, the linkage mechanism 500 may be an elongated linkage member (not shown in the figure). One end of the linkage member is pivotally connected to the armrest support rod 200, and the other end of the linkage member is pivotally connected to the locking pin 420. When the backrest support rod 300 and the armrest support rod 200 are in the unfolded position, an end of the locking pin 420 away from the linkage member can be inserted into the locking groove 412c of the locking member 410. When the backrest support rod 300 is folded in the direction approaching the armrest support rod 200, the linkage member is pivoted with the backrest support rod 300, and simultaneously drives the locking pin 420 to move in the direction away from the locking member 410, so that the locking mechanism 400 is unlocked and the armrest support rod 200 is folded with the backrest support rod 300. Further, a tension spring (not shown in the figure) may be arranged between a front end of the seat body 110 and the armrest support rod 200. When the armrest support rod 200 is folded, the tension spring is compressed, and when the backrest support rod 300 is unfolded and does not press against the armrest body 600, the armrest support rod 200 returns to the unfolded position under an elastic force of the tension spring.

The foldable carrier 10 and the child carrying device as described above have at least the following technical effects.

In the above foldable carrier 10, both the armrest support rod 200 and the backrest support rod 300 have a folded position and an unfolded position. When the foldable carrier 10 is required to be folded, only the backrest support rod 300 is required to be folded in the direction approaching the armrest support rod 200, which can drive, through the linkage mechanism 500, the locking mechanism 400 to be unlocked, so that the armrest support rod 200 can be rotated relative to the side plate 120, and the armrest support rod 200 can be rotated from the unfolded position to the folded position with the backrest support rod 300, so as to realize overall folding of the foldable carrier 10 without disassembling the armrest support rod 200, which is convenient to use.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only illustrate several embodiments of the present application, and description thereof is specific and detailed, but cannot therefore be understood as a limitation on the patent scope of the present application. It should be noted that those of ordinary skill in the art may further make variants and improvements without departing from the conception of the present application, and these all fall within the protection scope of the present application. Therefore, the patent protection scope of the present application should be subject to the appended claims.

1. A foldable carrier, comprising:
a seat assembly;
an armrest support rod pivotable relative to the seat assembly to move between a folded position and an unfolded position;
a backrest support rod having a folded position and an unfolded position;
a locking mechanism configured to lock the armrest support rod in the unfolded position relative to the seat assembly; and
a linkage mechanism arranged between the armrest support rod and the backrest support rod, wherein the backrest support rod is capable of being folded in a direction approaching the armrest support rod to drive the linkage mechanism to move to unlock the locking mechanism, so that the armrest support rod is capable of being rotated to the folded position.

2. The foldable carrier according to claim 1, wherein the seat assembly comprises a side plate, the locking mechanism comprises a locking member and a locking pin, and wherein the locking member is pivotally connected to the side plate at a first pivot point, and is fixedly connected to the armrest support rod; the locking member is provided with a locking groove; and the locking pin is movably arranged on the side plate and capable of being inserted into the locking groove.

3. The foldable carrier according to claim 2, wherein the backrest support rod is capable of being folded in the direction approaching the armrest support rod to drive the linkage mechanism to move, so that the locking pin moves in a direction away from the locking member.

4. The foldable carrier according to claim 3, wherein the linkage mechanism comprises a driving member, a transmission member, and a pulling member, and
wherein the driving member is fixedly connected to the backrest support rod, the driving member abuts against the transmission member, two ends of the pulling member are connected to the transmission member and the locking pin respectively, and the backrest support rod is capable of being folded in the direction approaching the armrest support rod to drive the driving member to push against the transmission member to move, so as to drive, through the pulling member, the locking pin to move in the direction away from the locking member.

5. The foldable carrier according to claim 4, wherein the linkage mechanism further comprises a winding post arranged on a side of the transmission member away from the locking pin, and
wherein one end of the pulling member is connected to the transmission member, the other end of the pulling member is wound around the winding post and is connected to the locking pin, and the backrest support rod is capable of being folded in the direction approaching the armrest support rod, to drive the driving member to push against the transmission member to move in a direction approaching the locking member.

6. The foldable carrier according to claim 4,
wherein the side plate is provided with an elongated hole, and the transmission member extends through the elongated hole and is movable along the elongated hole.

7. The foldable carrier according to claim 4,
wherein the driving member is pivotally connected to the side plate at a second pivot point, the driving member comprises an arc-shaped edge configured for abutting against the transmission member, and
wherein as the backrest support rod is folded in the direction approaching the armrest support rod, a distance from an abutment point of the arc-shaped edge against the transmission member to the second pivot point gradually increases.

8. The foldable carrier according to claim 2,
wherein the locking mechanism further comprises a first reset member, the first reset member constantly enabling the locking pin to move in a direction approaching the locking member.

9. The foldable carrier according claim 2,
wherein the locking mechanism further comprises a second reset member, the locking member has a first position and a second position, and
wherein when the armrest support rod is in the unfolded position, the locking member is in the first position, and when the armrest support rod is in the folded position, the locking member is in the second position, and the second reset member constantly enabling the locking member to rotate toward the first position.

10. The foldable carrier according to claim 9, wherein the side plate is provided with a limiting member, and when the locking member is in the first position, a side of the locking member adjacent to the second reset member abuts against the limiting member.

11. The foldable carrier according to claim 2,
wherein a first mating portion is arranged on the armrest support rod, and a second mating portion is arranged on the locking member, and the armrest support rod and the locking member are arranged on two sides of the side plate respectively.

12. The foldable carrier according to claim 11, wherein the first mating portion is one of a mating protrusion and a mating recess, and the second mating portion is the other of the mating protrusion and the mating recess, and wherein the mating protrusion extends through the side plate to be mated with the mating recess.

13. The foldable carrier according to claim 2,
wherein the seat assembly further comprises a seat body, two opposite sides of the seat body being each provided with the side plate, the armrest support rod, the backrest support rod, the locking mechanism, and the linkage mechanism, and
wherein the two side plates are connected to the two sides of the seat body respectively.

14. A child carrying device, comprising a carrier frame and the foldable carrier according to claim 1.

15. The child carrying device according to claim 14, wherein the child carrying device is a child stroller, a high chair, or a child dining chair.
